(19) United States
(12) Patent Application Publication
(10) Pub. No.: US 2024/0069741 A1
(43) Pub. Date: Feb. 29, 2024

(54) DYNAMIC WEAR LEVELING TECHNIQUES

(71) Applicant: Micron Technology, Inc., Boise, ID (US)

(72) Inventors: Luigi Esposito, Piano di Sorrento (NA) (IT); Paolo Papa, Grumo Nevano (NA) (IT)

(21) Appl. No.: 17/899,341

(22) Filed: Aug. 30, 2022

(51) Int. Cl. G06F 3/06; G06F 12/02

(52) U.S. Cl. CPC G06F 3/0616; G06F 3/0653; G06F 3/0679; G06F 12/0292; G06F 2212/1036

(57) ABSTRACT

Methods, systems, and devices for dynamic wear leveling techniques are described. A memory system may determine a type of data associated with data to be written to a block of the memory system. The memory system may determine the type of data based on a value of a counter associated with a segment of a mapping of the memory system that includes a logical address of the data. Additionally, or alternatively, the memory system may determine the type of data based on determining a quantity of invalid data in a set of recently selected (e.g., opened) blocks of the memory system. The memory system may select the block for storing the data based on the type of data and a quantity of times that the block has been erased and write the data to the selected block.

### FIELD OF TECHNOLOGY

The following relates to one or more systems for memory, including dynamic wear leveling techniques.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports dynamic wear leveling techniques in accordance with examples as disclosed herein.

FIG. 2 illustrates an example of a system that supports dynamic wear leveling techniques in accordance with examples as disclosed herein.

FIG. 3 illustrates an example of a system that supports dynamic wear leveling techniques in accordance with examples as disclosed herein.

FIG. 4 illustrates an example of a process flow that supports dynamic wear leveling techniques in accordance with examples as disclosed herein.

FIG. 5 shows a block diagram of a memory system that supports dynamic wear leveling techniques in accordance with examples as disclosed herein.

FIG. 6 shows a flowchart illustrating a method or methods that support dynamic wear leveling techniques in accordance with examples as disclosed herein.

### DETAILED DESCRIPTION

In some memory architectures, memory cells may degrade over an operable life of a memory system. For example, some non-volatile memory cells (e.g., not-and (NAND) memory cells, among other examples) may degrade as a quantity of access operations accumulate (e.g., program operations, erase operations, media management operations, other operations, or various combinations thereof). If enough blocks fail, the memory system may cease to function for its intended purposes. To extend the operable life, a memory system may implement wear leveling techniques to mitigate adverse effects associated with certain memory cells degrading at different rates (e.g., more quickly) than others, which may include distributing access-based degradation more evenly across memory cells of the memory system. For example, the memory system may select (e.g., open) blocks for writing data based on an “age” of the blocks, where the age of a block may increase as a quantity of times that the block has been erased increases. In some examples, older blocks (e.g., blocks that have been erased a relatively larger quantity of times) may be associated with more degradation (e.g., an increased likelihood of degradation) than younger blocks (e.g., blocks that have been erased a relatively smaller quantity of times). In some wear leveling implementations, the memory system may write data (e.g., cold data) expected to be associated with a relatively higher expected life duration (e.g., low likelihood of being overwritten/invalidated within a threshold period of time after being written) to older blocks and data (e.g., hot data) expected to be associated with a relatively lower expected life duration (e.g., high likelihood of being overwritten/invalidated within a threshold period of time after being written) to the younger blocks.

In some cases, such wear leveling techniques may not support performing wear leveling in accordance with varying host usage models (e.g., user-specified models, predictive models). For example, in some cases, a type of the data that is written may not be explicitly known, but may instead be determined by the memory system based on one or more parameters of the data and one or more general expectations about a host usage model. For instance, the memory system may expect that, in accordance with a general host usage model, large chunk data or data collected via garbage collection may be cold data and may thus select relatively older blocks for writing the data. However, some host usage models may overwrite large chunk data or garbage collected data relatively frequently, and such data should instead be classified as relatively hotter data. Accordingly, the parameters for selecting blocks for wear leveling may be ineffective or even counterproductive to distributing wear across the blocks of the memory system.

In accordance with examples as described herein, a memory system may implement dynamic wear leveling techniques for determining (e.g., predicting) a type of data to be written to a block of the memory system and selecting (e.g., opening) the block based on the age of the block and the type of data. For example, the memory system may determine the type of data to be written to the block (e.g., prior to selecting the block for writing the data) based on various types of information tracked by the memory system, which may support adapting wear leveling techniques to varying host usage models. For instance, the memory system may track the quantity of times that data is written to a logical address of a segment (e.g., portion, logical address range) of a mapping table (e.g., a logical-to-physical (L2P) table). As the quantity of increases, the “hotness” of data written to segment may increase. Additionally or alternatively, the memory system may track a quantity of invalidated data in blocks included in a list of one or more recently selected blocks. The quantity of invalidated data may be indicative of the life duration of data currently being written by the host, for example, with greater quantities of invalidated data being indicative shorter life durations, and vice versa.

The memory system may determine the type of data based on the tracked information and select the block based on the determined type of data. Accordingly, the memory system may override (e.g., overrule) a-priori expectations on a host usage model and instead select blocks for writing data based on dynamically determined data types. As such, the dynamic wear leveling techniques may support block selection that more accurately represents an actual host usage model for performing wear leveling. Additionally, implementing dynamic wear leveling as described herein will distribute wear across the blocks of the memory system more effectively and with greater flexibility, thereby increasing an operable life of the memory system, among other benefits.

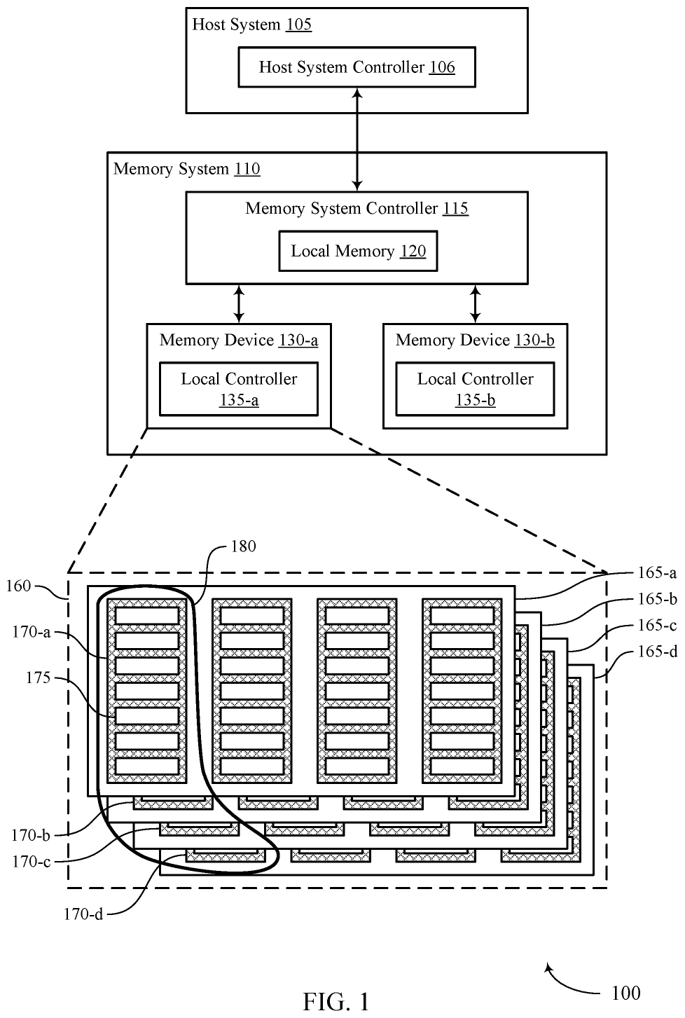

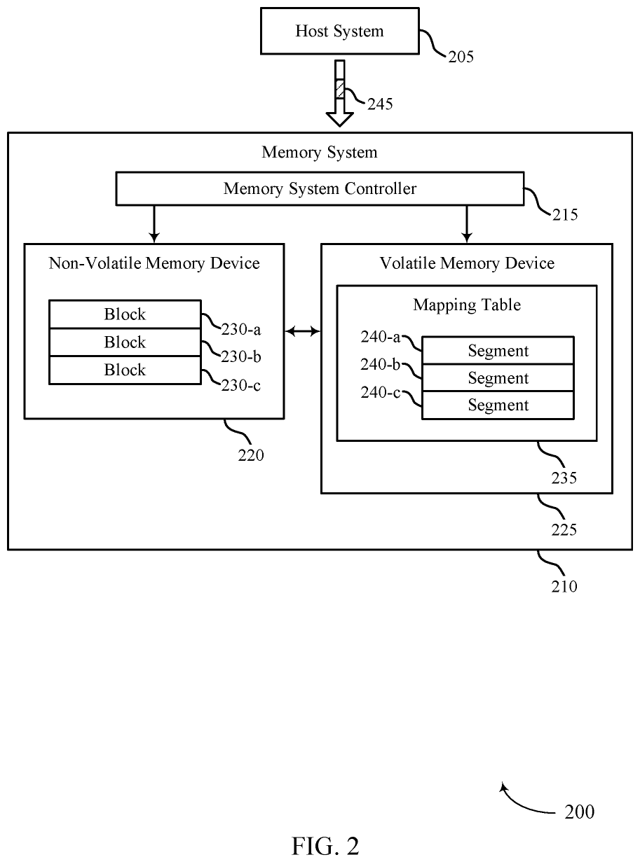

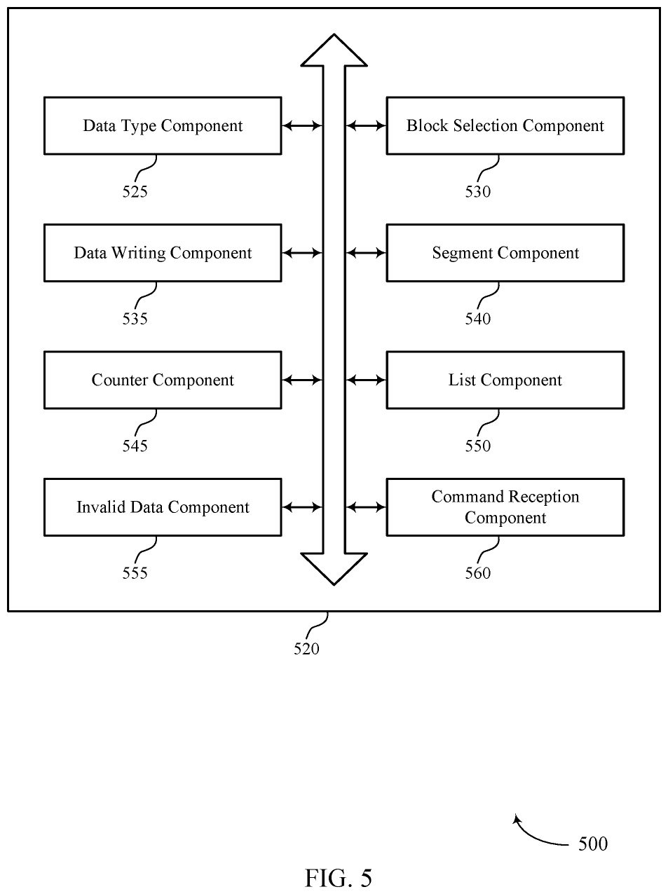

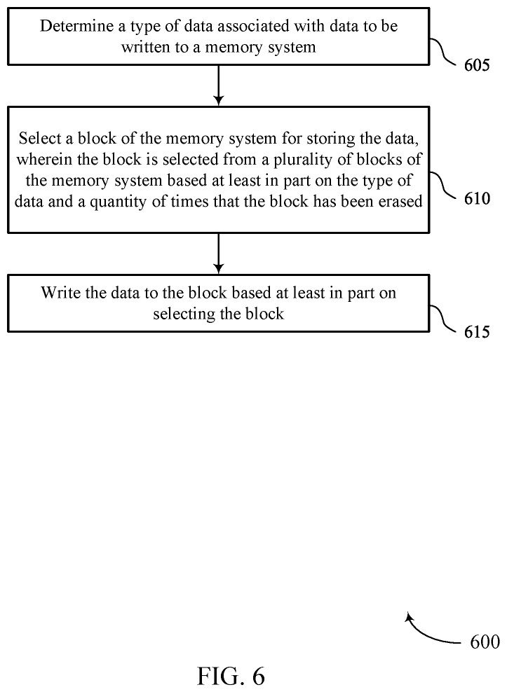

Features of the disclosure are initially described in the context of a system as described with reference to FIG. 1. Features of the disclosure are described in the context of systems and process flows with reference to FIGS. 2 through 4. These and other features of the disclosure are further illustrated by and described in the context of a block diagram and flowchart that relate to dynamic wear leveling techniques with reference to FIGS. 5 and 6.

FIG. 1 illustrates an example of a system 100 that supports dynamic wear leveling techniques in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, an L2P mapping table may be associated with accessing a range of logical block addresses of the memory system 110, corresponding to physical addresses of blocks 170 of the memory system 110. The L2P mapping table may include a quantity of segments, where each segment may be associated with accessing a subset of the range of logical block addresses of the memory system 110. In some cases, the L2P mapping table may be associated with a quantity of counters corresponding to the quantity of segments such that each segment of the L2P mapping table has an associated counter. In some examples, each counter may maintain a value associated with a quantity of times the segment has been updated by the firmware or otherwise accessed. That is, the value of a counter may be incremented (e.g., increased) as the segment corresponding to the counter is updated (e.g., as data is written to a logical address of the segment).

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The host system 105 and the memory system 110 may communicate various types of data. For example, the host system 105 and the memory system 110 may communicate data and node information, which may correspond to metadata associated with the communicated data. In some examples, the host system 105 and the memory system 110 may communicate data associated with different expected life durations (e.g., different likelihoods of being overwritten or invalidated, such as within a period of time), which may correspond to different types of data. For example, hot information (e.g., hot data, hot metadata) may be information that is expected to have a shorter life duration relative to other types of information. Cold information (e.g., cold data, cold metadata) may be information that is expected to have a longer life duration relative to other types of information. For instance, data corresponding to a photograph stored at the memory system 110 (among other types of data) may be data that is not expected to change or be overwritten in the near future (e.g., if at all) and may thus be considered cold data, whereas data associated with interactive video editing (among other types of data) may be data is expected to be overwritten relatively frequently and may thus be considered hot data. Various other “degrees” of temperature, such as warm information, may be information expected to have life durations at various ranges between those of hot information and cold information. That is, each type of information may be associated with a respective expected life duration of the information. In some examples, a type of information may be associated with an access frequency. For example, the more frequently that information is accessed (e.g., written, overwritten), the hotter the information may be, and vice versa. In some examples, the host system 105 may communicate an indication of the type of data to the memory system 110.

The memory system 110 may operate in accordance with cursors, which may be associated with locations (e.g., addresses) where data written to the memory system 110 may be stored. For example, the memory system 110 may store (e.g., write) data written to one or more logical addresses of the memory system at one or more physical addresses of a cursor. In some examples, a cursor may include one or more blocks of the memory system 110, such as one or more blocks 170 or virtual blocks 180. In some examples, a cursor may be used to store a single type of data (e.g., all data written to the cursor may be of the same type). In some examples, a cursor may be used to store multiple types of data.

In accordance with examples as described herein, the memory system 110 may implement dynamic wear leveling techniques for determining (e.g., predicting) a type of data to be written to a cursor of the memory system 110 and selecting (e.g., opening) the cursor based on an age of the cursor and the type of data. For example, the memory system 110 may determine (e.g., predict) the type of data to be written to the cursor (e.g., prior to selecting the cursor) for writing the data based on various types of information tracked by the memory system. For instance, the memory system 110 may track respective quantities of times that data is written to respective segments (e.g., portions) of an L2P mapping table, track a quantity of invalidated data in cursors included in a set (e.g., list) of recently selected cursors, or a combination thereof, and determine the type of data based on the tracked information. The memory system 110 may select the cursor for writing the data in accordance with the determined type of data.

By selecting cursors based on data types determined using the tracked information, the memory system 110 may override (e.g., overrule) a-priori expectations on a host usage model to support cursor selection that more accurately represents an actual host usage model for the wear leveling. Additionally, implementing dynamic wear leveling as described herein may distribute wear across the cursors of the memory system 110 more effectively and with greater flexibility, thereby increasing an operable life of the memory system, among other benefits.

The system 100 may include any quantity of non-transitory computer readable media that support dynamic wear leveling techniques. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

FIG. 2 illustrates an example of a system 200 that supports dynamic wear leveling techniques in accordance with examples as disclosed herein. The system 200 may be an example of and implement aspects of a system 100, as described with reference to FIG. 1. For example, the system 200 may include a host system 205 and a memory system 210, which may be examples of a host system 105 and a memory system 110 as described with reference to FIG. 1, respectively. In some cases, the memory system 210 may be configured to determine (e.g., predict) the type of data to be written to (e.g., prior to selecting) a block 230 of the memory system 210 and select the block 230 based on an age of the block 230 and the type of data determined by the memory system 210. Implementing dynamic wear leveling as described herein may distribute wear across the blocks 230 of the memory system 210 more effectively and with greater flexibility, thereby increasing an operable life of the memory system 210, among other benefits.

The system 200 may include the host system 205 and the memory system 210, where the memory system 210 may include a memory system controller 215, which may be an example of a memory system controller 115. The memory system 210 may include one or more non-volatile memory devices 220 (e.g., memory devices 130) and one or more volatile memory devices 225 (e.g., memory devices 130, local memory 120) in communication with one another. In some cases, the memory system controller 215 may facilitate communication between the host system 205, the non-volatile memory device 220, and the volatile memory device 225. In some examples, the non-volatile memory device 220 and the volatile memory device 225 may each include a local memory controller, such as a local controller 135 as described with reference to FIG. 1. In some examples, the volatile memory device 225 may be included in the memory system controller 215.

The non-volatile memory device 220 may include a quantity of blocks 230. In some cases, the blocks 230 may be examples of blocks 170 or virtual blocks 180, as described with reference to FIG. 1. In some cases, the blocks 230 may be examples of cursors, where each block 230 may represent a cursor of the memory system 210. The blocks 230 may be configured to store data received from the host system 205 as part of an access operation. In some cases, each block 230 may be associated with an extent of degradation (e.g., wear), for example, caused by repeated operations performed on each block 230 over time. For example, the blocks 230 of the memory system 210 may have a distribution of wear such that some blocks 230 may be associated with relatively greater degradation and some blocks 230 may be associated with relatively less degradation.

In some examples, the blocks 230 may be categorized (e.g., classified) based on the age of the blocks 230. For example, an older block 230-a (e.g., an old block 230-a) may be associated with a relatively greater quantity of erase operations. That is, the greater the quantity of times that a block 230 has been erased, the older the block 230 may be, for example, because the greater quantities of erase operations may correspond to a relatively longer lifetime of continued use, a relatively greater extent of degradation, or a combination thereof. In another example, a younger block 230-c (e.g., a young block 230-c) may be associated with a relatively lower quantity of erase operations (e.g., a relatively shorter lifetime of continued use, a relatively lower extent of degradation). That is, the smaller the quantity of times that a block 230 has been erased, the younger the block 230 may be. In some implementations, an intermediate block 230-b may be associated with a quantity of erase operations greater than the young block 230-c but less than the old block 230-a (e.g., a lifetime of continued use greater than the young block 230-c but less than the old block 230-a, an extent of degradation greater than the young block 230-c but less than the old block 230-a).

To extend the operable life of the blocks 230, the memory system 210 may implement wear leveling techniques, which may include distributing access-based degradation more evenly across the blocks 230. In some wear leveling implementations, the memory system 210 may select a block 230 for writing data based on an age of the block 230 and general expectations about a usage model implemented by the host system 205. However, in some cases, the host system 205 may write data in a manner different from the generally expected model, which may result in the memory system 210 selecting older blocks 230 for the storage of hot data that is likely to be overwritten soon. Such storage may result in the older blocks 230 being erased relatively soon, thereby further increasing the age of the blocks 230 and resulting in greater unevenness of the distribution of wear across the blocks 230. Accordingly, the parameters for selecting blocks 230 for wear leveling may be ineffective or even counterproductive.

In accordance with examples described herein, the memory system 210 may track information that enables the memory system 210 to dynamically (e.g., flexibly, adaptively) determine a type of data written to a block 230, thereby enabling the memory system 210 to select blocks 230 for storing the data such that even distribution of wear across the blocks 230 is improved. For instance, in the example of FIG. 2, the memory system 210 may track respective quantities of times that data is written to logical addresses within various ranges of logical addresses. The greater the quantity of times that data is written to a logical address within a given range (e.g., relative to other ranges), the hotter that data written to logical addresses with the range may be considered by the memory system 210, and vice versa. Accordingly, the memory system 210 may determine the type of data and select (e.g., open) younger blocks 230 for storing hot data, and vice versa.

To support such tracking, the memory system 210 may leverage aspects of a mapping used to map logical addresses to physical addresses of the memory system 210. For example, the volatile memory device 225 may include a mapping table 235 for mapping logical addresses (e.g., LBAs) of blocks 230 to physical locations (e.g., physical addresses, physical block addresses) of the blocks 230. In some examples, the mapping table 235 may be an example of an L2P mapping table as described with references to FIG. 1. The mapping table 235 may include a range of logical addresses of the memory system 210, where the range of logical addresses may correspond to a range of physical addresses of blocks 230. In some cases, the mapping table 235 may include segments 240, where each segment 240 is associated with a subset of logical addresses of the range of logical addresses. For example, segment 240-a may be associated with a first subset of contiguous logical addresses, segment 240-b may be associated with a second subset of contiguous logical addresses, and segment 240-c may be associated with a third subset of contiguous logical addresses, where each subset of logical addresses may include different logical addresses (e.g., the subsets may be non-overlapping).

In some cases, the segments 240 of the mapping table 235 may be associated with a respective level of granularity. For example, the mapping table 235 may be a multi-level mapping table in which logical addresses are mapped to physical addresses via two or more levels of entries (e.g., sub-tables). For instance, in a three-level mapping table, an entry of a first level may map to a set of entries of a second level, an entry of the second level may map to a set of entries of a third level, and an entry of a third level may include the mapped-to physical address. In some examples, a segment 240 may correspond to an entry of an upper level (e.g., the second level). For example, the segment 240 may include logical addresses spanned by an entry of an upper level (e.g., third level entries to which a second level entry may be mapped). In some cases, the non-volatile memory device 220 may store the mapping table 235 and portions (e.g., segments 240, portions of respective levels) of the mapping table 235 may be transferred to and from the volatile memory device 225, for example, to use (e.g., update, reference, read) the portions of the mapping table 235.

The memory system 210 may track the quantities of times that data is written to respective segments 240 and use such tracked information in determining data types for block selection. To support such tracking, the memory system 210 may generate a quantity of counters corresponding to the segments 240 of the mapping table 235. For example, the volatile memory device 225 may include and maintain a counter for each segment 240 of the mapping table 235. Each counter may be used to track the quantity of times that a logical address in the subset of logical addresses associated with the segment 240 corresponding to the counter has been accessed. For example, segment 240-a may be associated with a first counter, where the first counter may include a value corresponding to the quantity of times that logical addresses of the segment 240-a have been written to. In such an example, each time a logical address of the segment 240-a is written to, the memory system 210 may increment (e.g., increase) the value of the counter to reflect the quantity of times that the segment 240-a has been updated.

The memory system 210 may obtain data (e.g., data, metadata) to be written to the blocks 230 and update counters associated with a logical address of the data accordingly. In some cases, the memory system 210 may obtain the data as part of a write command. For example, the memory system 210 receive an access command 245 (e.g., a write command) from the host system 205, where the access command 245 may include the data and indicate for the memory system 210 to write the data to a logical address of the non-volatile memory device 220. In some examples, the access command 245 may include an indication of the type of data as determined by the host system 205. In some cases, the memory system 210 may obtain (e.g., collect, read, receive) the data and determine the logical address as part of a garbage collection procedure. In an example in which the logical address is included in the segment 240-a, the memory system 210 may determine (e.g., identify) that the segment 240-a includes the logical address (e.g., indicated via the access command 245, determined as part of the garbage collection procedure), write the data to a physical address corresponding to the logical address, and increment the first counter associated with the segment 240-a. In some examples, the memory system 210 may increment the first counter prior to writing the data (e.g., based on determining that the logical address is included in the segment 240-a) or after or concurrent with writing the data.

The memory system 210 may write the data based on a value of the first counter associated with the segment 240-a. For example, the memory system 210 may determine the value of the first counter corresponding to the segment 240-a and compare the value of the first counter to values of other counters corresponding to other segments 240 of the mapping table 235. Additionally or alternatively, the memory system 210 may compare the value of the first counter to one or more thresholds associated with respective types of data. In some cases, the memory system 210 may increment the value of the first counter prior to determining the value of the first counter for comparing the value of the first counter to the values of the other counters or comparing the value of the first counter to the one or more thresholds.

The memory system 210 may determine a type of the data based on the comparison of the value of the first counter to the other counters, the one or more thresholds, or a combination thereof. In some cases, the memory system 210 may determine the type of data is hot data based on the value of the counter being greater than the values of the other counters (e.g., greater than a threshold quantity of the values of the other counters), the value of the first counter satisfying (e.g., meeting or exceeding) a threshold associated with hot data, or both. In some cases, the memory system 210 may determine the type of data is cold data based on the value of the counter being less than the values of the other counters (e.g., less than or equal to a threshold quantity of values of the other counters), the value of the counter failing to satisfy (e.g., is less than, is less than or equal to) a threshold associated with cold data, or both. In some examples, the hot data threshold and the cold data threshold may be the same threshold. In some cases, the memory system 210 may determine the type of data is warm data based on the value of the counter being greater than a first quantity of the values of the other counters but less than a second quantity of the values of the other counters, satisfying a threshold associated with warm data (e.g., but failing to satisfy the hot data threshold), satisfying the cold data threshold but failing to satisfy the hot data threshold, or any combination thereof. Other data types of varying “temperatures” may be similarly determined by the memory system 210 based on a value of the first counter.

In some cases, the memory system 210 may receive an indication of the type of data from the host system 205 (e.g., as part of the access command 245) and determine the type of the data in conjunction with the comparison of the value of the first counter. For instance, the memory system 210 may determine the type of data based on a weighted combination of the indication from the host system 205 and the type of data as determined by the memory system 210. For example, the host system 205 may indicate the data as cold data, but the memory system 210 may determine the type of data as hot data using the value of the first counter. In some examples, the memory system 210 may weight the indication and determination based on previous accuracy of the data type indications. For example, if the memory system 210 determines that previous indications of the data type have been relatively inaccurate (e.g., the host system 205 indicates cold data but subsequently overwrites the data relatively quickly), the memory system 210 may weight the hot data determination based on the counter value more heavily and determine that the data is hot data. If the previous data indications have been relatively accurate, the memory system 210 may weight the cold data indication more heavily and determine that the data is cold data. In some examples, the previous accuracy of the data type indications may be such that the memory system 210 weights the cold data indication and the hot data determination relatively evenly, and the memory system 210 may, for example, determine that the data is warm data.

The memory system 210 may determine the type of data prior to (e.g., in conjunction with) selecting a block 230 for storing the data. In response to determining the type of data, the memory system 210 may select the block 230 for storing the data based on the type of data and the age of the block 230. In some cases, the memory system 210 may select the block 230 based on an inverse relationship between the age of the block 230 and the type of data, such that younger blocks 230 (e.g., the block 230-c) may be selected for hotter data, older blocks 230 (e.g., the block 230-a) may be selected for colder data, and so on. For example, the memory system 210 may select the old block 230-a (e.g., a block 230 having been erased greater than a threshold quantity of times) for storing the data based on determining the type of data is cold data. Alternatively, the memory system 210 may select the young block 230-c (e.g., a block 330 having been erased less than a threshold quantity of times) for storing the data based on determining the type of data is hot data. In some instances, the memory system 210 may select the intermediate block 230-b (e.g., a block 330 having been erased less than a first threshold quantity of times and more than second threshold quantity of times that is less than the first threshold quantity of times) for storing the data based on determining the type of data is warm data.

Implementing dynamic wear leveling techniques as described herein may support determining the type of data to be written to blocks 230 of the memory system 210 and selecting blocks 230 based on the age of the blocks 230 and the type of data determined by the memory system 210 (e.g., a weighted combination of the indication and determined type of data). Using the dynamic wear leveling techniques described herein may allow the memory system 210 to predict the type of data to be written to the memory system 210 prior to selecting the block 230 for storing the data, thereby supporting more flexibility for selecting the block 230 based on the type of data. For example, instead of selecting a block 230 for wear leveling based on general expectations about a host usage model, the dynamic wear leveling techniques may support block 230 selection that more accurately represents a usage model implemented by the host system 205 for the wear leveling. For example, using the dynamic wear leveling techniques described herein may allow greater flexibility for modeling usage of the memory system 210, which may vary across applications of the system 200. Additionally, implementing dynamic wear leveling as described herein may distribute wear across the blocks 230 of the memory system 210 more accurately and effectively, thereby increasing an operable life of the memory system 210, among other benefits.

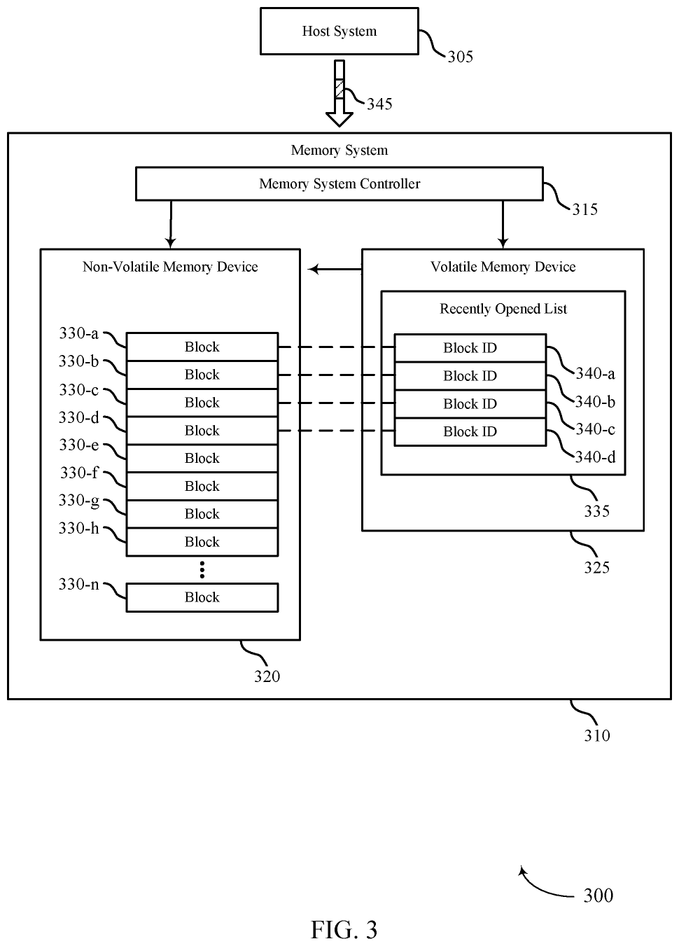

FIG. 3 illustrates an example of a system 300 that supports dynamic wear leveling techniques in accordance with examples as disclosed herein. The system 300 may be an example of and implement aspects of a system 100 or a system 200, as described with reference to FIGS. 1 and 2, respectively. For example, the system 300 may include a host system 305 and a memory system 310, which may be examples of a host system 105, 205 and a memory system 110, 210 as described with reference to FIGS. 1 and 2, respectively. In some cases, the memory system 310 may be configured to determine (e.g., predict) the type of data to be written to (e.g., prior to selecting) a block 330 of the memory system 310 and select the block 330 based on an age of the block 330 and the type of data determined by the memory system 310. Implementing dynamic wear leveling as described herein may distribute wear across the blocks 330 of the memory system 310 more effectively and with greater flexibility, thereby increasing an operable life of the memory system 210, among other benefits.

The system 300 may include the host system 305 and the memory system 310, where the memory system 310 may include a memory system controller 315 (e.g., a memory system controller 115, 215). The memory system 310 may include one or more non-volatile memory devices 320 (e.g., memory devices 130, 220) and one or more volatile memory device 325 (e.g., memory devices 130, 225, local memory 12) in communication with one another. In some cases, the memory system controller 315 may facilitate communication between the host system 305, the non-volatile memory device 320, and the volatile memory device 325. The non-volatile memory device 320 may include a quantity of blocks 330, which may be examples of the blocks 230 described with reference to FIG. 2.

In some examples, the blocks 330 may be categorized based on the age of the blocks 330. For example, the greater a quantity of times that a block 330 has been erased, the older the block 330 may be considered.

In accordance with examples described herein, the memory system 310 may track information that enables the memory system 310 to dynamically (e.g., flexibly, adaptively) determine a type of data written to a block 330, thereby enabling the memory system 310 to select blocks 330 for storing the data such that even distribution of wear across the blocks 330 is improved. For instance, in the example of FIG. 3, the memory system 310 may track how much data included in a set of recently selected blocks 330 has been invalidated. The greater quantity of invalidated data, the hotter the data being written by the host system 305 may be, and vice versa. Accordingly, the memory system 310 may determine the type of data and select (e.g., open) younger blocks 330 for storing hot data, and vice versa.

To support such invalid data tracking, the memory system 310 may implement a list 335 of previously selected (e.g., opened) blocks 330. For example, the memory system 310 may generate and maintain (e.g., using the volatile memory device 325) the list 335, where the list 335 may include a set of block identifiers 340 (e.g., block IDs 340) and each block ID 340 may correspond to a block 330 of the non-volatile memory device 320. In some cases, the block IDs 340 may correspond to a quantity of blocks 330 most recently opened by the memory system 310 (e.g., most recently selected by the memory system 310 for writing data). In some examples, the list 335 may include a quantity of block IDs 340 corresponding to a threshold quantity of blocks 330 as compared to a total quantity of blocks 330 of the memory system 310. For example, the list 335 may maintain block IDs 340 for a threshold quantity of blocks 330 corresponding to the most recently selected X % (e.g., 2%, 5%, 10%, or another percentage) of the total quantity of blocks 330 of the memory system 310. For example, the list 335 may include block IDs 340-a, 340-b, 340-c, and 340-d corresponding to blocks 330-a, 330-b, 330-c, and 330-d, due to the blocks 330-a, 330-b, 330-c, and 330-d corresponding to the most recently opened blocks 330 that are within the threshold percentage of the total quantity of blocks 330. Accordingly, the list 335 may not include block IDs 340 corresponding to blocks 330-e through 330-n, due to the blocks 330-e through 330-n not being within the threshold percentage of the most recently opened blocks 330.

The memory system 310 may track the quantity of invalid data in the blocks 330 corresponding to the block IDs 340 in the list 335. For example, the list 335 may include block IDs 340-a through 340-d, and thus the memory system 310 may track the quantity of invalid data in the blocks 330-a through 330-d. In some cases, the memory system 310 may use the quantity of invalid data in the recently opened blocks 330 (e.g., blocks 330-a through 330-d) to determine a host usage model of the memory system 310 (e.g., a usage model implemented by the host system 305), such that the host usage model may more accurately reflect operations of the memory system 310 for use in wear leveling. For example, the memory system 310 may use the quantity of invalid data in the recently opened blocks 330 to determine (e.g., predict) a type of data. In some examples, the memory system 310 may determine a relatively large quantity of invalid data in the recently opened blocks 330 and may therefore determine the type of data is hot data. In other examples, the memory system 310 may determine a relatively small quantity of invalid data in the recently opened blocks 330 and may therefore determine the type of data is cold data. In some examples, the memory system 310 may determine an intermediate quantity of invalid data in the recently opened blocks 330 and may therefore determine the type of data is warm data. The memory system 310 may determine the type of data based on comparing the quantity of invalid data to one or more threshold quantities of invalid data.

The memory system 310 may obtain data (e.g., data, metadata) to be written to the blocks 330 according to various techniques. In some cases, the memory system 310 may receive an access command 345 (e.g., write command) from the host system 305 that includes the data, and the memory system 310 may write the data to a block 330 in response to the access command 345. In some examples, the access command 345 may include an indication of the type of data as determined by the host system 305. In some cases, the memory system 310 may obtain the data as part of a garbage collection procedure.

In response to obtaining the data, the memory system 310 may determine the type of data based on determining the quantity of invalid data in the recently opened blocks 330. In some cases, the memory system 310 may determine the type of data is hot data based on determining that the quantity of invalid data in the recently opened blocks 330 satisfies (e.g., meets or exceeds) a threshold quantity of invalid data associated with hot data. In some cases, the memory system 310 may determine the type of data is cold data based on determining that the quantity of invalid data in the recently opened blocks 330 fails to satisfy (e.g., is less than, is less than or equal to) a threshold quantity of invalid data associated with cold data. In some examples, the hot data threshold and the cold data threshold may be the same threshold. In some cases, the memory system 310 may determine the type of data is warm data based on determining that the quantity of invalid data in the recently opened blocks 330 satisfies a threshold quantity of invalid data associated with warm data (e.g., but fails to satisfy the hot data threshold). In some the memory system 310 may determine the type of data is warm data based on determining that the quantity of invalid data satisfies the cold data threshold but fails to satisfy the hot data threshold. Other data types of varying “temperatures” may be similarly determined by the memory system 310 based on the quantity of invalid data in the recently opened blocks 330.

In some cases, the memory system 310 may receive an indication of the type of data from the host system 305 (e.g., as part of the access command 345) and determine the type of the data in conjunction with the comparison of the quantity of invalid data in the recently opened blocks 330. For instance, the memory system 310 may determine the type of data based on a weighted combination of the indication from the host system 305 and the type of data as determined by the memory system 310 (e.g., based on an accuracy associated with data type indications received from the host system 305).

The memory system 310 may determine the type of data prior to (e.g., in conjunction with) selecting a block 330 for storing the data. In response to determining the type of data, the memory system 310 may select the block 330 for storing the data based on the type of data and the age of the block 330. In some cases, the memory system 310 may select the block 330 based on an inverse relationship between the age of the block 330 and the type of data, such that younger blocks 330 may be selected for hotter data. For example, the memory system 310 may select an older block 330 (e.g., a block 330 having been erased more than a threshold quantity of times) for storing the data based on determining the type of data is cold data. Alternatively, the memory system 310 may select a younger block 330 (e.g., a block 330 having been erased less than a threshold quantity of times) for storing the data based on determining the type of data is hot data. In some instances, the memory system 310 may select an intermediate block 330 (e.g., a block 330 having been erased less than a first threshold quantity of times and more than second threshold quantity of times that is less than the first threshold quantity of times) for storing the data based on determining the type of data is warm data.

Implementing dynamic wear leveling techniques as described herein may support determining the type of data to be written to blocks 330 of the memory system 310, and selecting blocks 330 based on the age of the blocks 330 and the type of data determined by the memory system 310 (e.g., a weighted combination of the indication and determined type of data). Using the dynamic wear leveling techniques described herein may allow the memory system 310 to predict the type of data to be written to the memory system 310 prior to selecting the block 330 for storing the data, thereby supporting more flexibility for selecting the block 330 based on the type of data and in accordance with a more accurate host usage model, thereby supporting the distribution of wear across the blocks 330 of the memory system 310 more accurately and effectively, among other benefits.

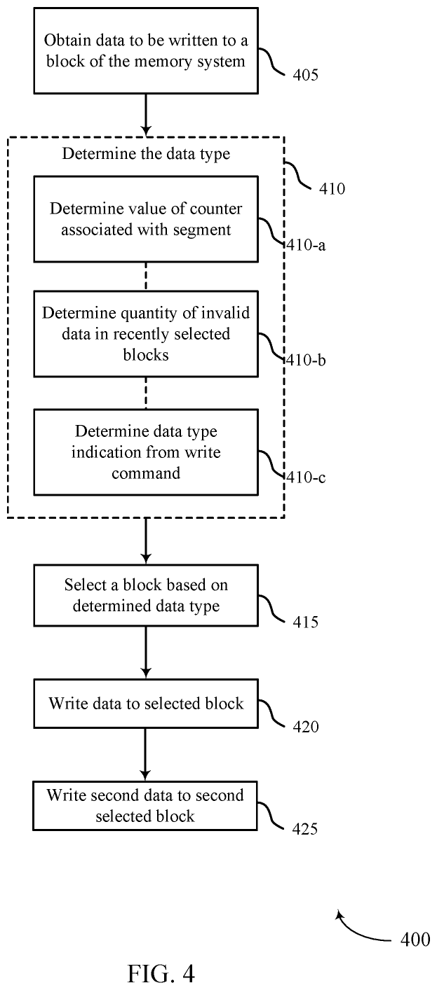

FIG. 4 illustrates an example of a process flow 400 that supports dynamic wear leveling techniques in accordance with examples as disclosed herein. The process flow 400 may illustrate aspects or operations of systems 100, 200, or 300, as described with reference to FIGS. 1 through 3, respectively. For example, the process flow 400 may depict operations at a memory system or a host system, which may be examples of a memory system 110, 210, 310 and a host system 105, 205, 305, respectively, as described with reference to FIGS. 1 through 3. In the following description of the process flow 400, the methods, techniques, processes, and operations may be performed in different orders or at different times. Further, certain operations may be left out of the process flow 400, or other operations may be added to the process flow 400. The operations described herein may distribute wear across blocks of the memory system more effectively based on modeling usage of the memory system, thereby providing greater flexibility for performing dynamic wear leveling, among other benefits.

Aspects of the process flow 400 may be implemented by a controller, among other components. Additionally, or alternatively, aspects of the process flow 400 may be implemented as instructions stored in memory (e.g., firmware stored in a memory coupled with a memory system or a host system). For example, the instructions, when executed by a controller (e.g., the memory system or host system), may cause the controller to perform the operations of the process flow 400.

At 405, data may be obtained to be written to a block (e.g., a virtual block, a cursor) of the memory system. For example, the memory system may obtain the data via an access command (e.g., a write command) from the host system, or as part of a garbage collection procedure performed by the memory system. The data may be associated with a logical address of the memory system (e.g., for storing the data). In some examples, the access command may include an indication of a type of data as determined by the host system.

At 410, the type of data may be determined. In some cases, the memory system may determine the type of data in accordance with various techniques described herein. For example, the memory system may determine the type of data using a value of a counter, a quantity of invalid data associated with a list of previously selected blocks (e.g., a list 335), the indication of the type of data from the host system, or any combination thereof.

For instance, at 410-a, the type of data may be determined by determining the value of the counter associated with a segment of the memory system that includes the logical address of the data. The memory system may include a quantity of segments (e.g., segments 240) of a mapping table (e.g., an L2P mapping table) that maps logical addresses to physical addresses of the blocks of the memory system. Each segment may be associated with a subset of logical addresses of a range of logical addresses of the memory system (e.g., one or more memory arrays of the memory system). Each segment may be associated with a counter that tracks the quantity of times that data is written to the subset of logical addresses associated with the segment. Accordingly, each time data is written to a logical address in the subset of logical addresses associated with the segment, the counter may increment (e.g., update, increase) the value corresponding to the segment. For example, the segment may contain the logical address of the data, and the memory system may update the counter associated with the logical address (e.g., prior to storing the data to the logical address, after storing the data to the logical address). The memory system may determine (e.g., predict) the type of data using the value of the counter, for example, by comparing the value of the counter to one or more thresholds, to values of other counters associated with other segments, or a combination thereof.

At 410-b, the type of data may be determined by determining the quantity of invalid data associated with the list previously selected blocks. The memory system may include (e.g., generate, maintain, updated) a list of recently opened blocks (e.g., a list of IDs associated with the recently opened blocks), for example, corresponding to the most recent threshold quantity of selected blocks. The memory system may track the quantity of invalid data in the blocks of the list. The memory system may determine (e.g., predict) the type of data by comparing the quantity of invalid data in the blocks of the recently opened list to one or more threshold quantities of invalid data.

At 410-c, the type of data may be determined by determining the type of data as indicated by the access command. For example, the host system may indicate the type of data via the access command. In some cases, the memory system 210 may use a weighted combination of the methods described at 410-a, 410-b, and 410-c, such that the type of data may be determined based on the value of the counter, the quantity of invalid data, the indication of the type of data from the host system, or a combination thereof.

At 415, the block for storing the data may be selected based on determining the type of data. For example, in response to determining the type of data, the memory system may select the block for storing the data based on the type of data and the age of the block (e.g., the quantity of times that the block has been erased). In some cases, the memory system may select the block based on an inverse relationship between the quantity of times that the block has been erased and the type of data, such that blocks having been erased fewer quantities of times may be selected for hotter data. For example, the memory system may select an older block (e.g., a block having been erased a threshold quantity of times) for storing the data based on determining the type of data is cold data. Alternatively, the memory system may select a younger block for storing the data based on determining the type of data is hot data. In some instances, the memory system may select an intermediate block (e.g., a block having been erased less than a first threshold quantity of times and more than a second threshold quantity of times) for storing the data based on determining the type of data is warm data.

At 420, the data may be written to the block selected at 415. For example, the memory system may write the data to the selected block.

At 425, second data may be written to second selected block. For example, the memory system may obtain second data for writing to a block of the memory system. The memory system may determine a type of the second data and select the second block based on the determined type and an age of the second block (e.g., a quantity of times that the second block has been erased). In some examples, the second quantity of times that the second block has been erased is greater than or less than the quantity of times that the block has been erased based on the respective types of data. For example, if the data is hotter than the second data (e.g., the data is associated with a shorter expected life duration than the second data), the second quantity of times that the second block has been erased may be greater than the quantity of times that the block has been erased (e.g., the second block may be older than the block). Alternatively, if the data is colder than the second data (e.g., the data is associated with a longer expected life duration than the second data), the second quantity of times that the second block has been erased may be less than the quantity of times that the block has been erased (e.g., the second block may be younger than the block).

FIG. 5 shows a block diagram 500 of a memory system 520 that supports dynamic wear leveling techniques in accordance with examples as disclosed herein. The memory system 520 may be an example of aspects of a memory system as described with reference to FIGS. 1 through 4. The memory system 520, or various components thereof, may be an example of means for performing various aspects of dynamic wear leveling techniques as described herein. For example, the memory system 520 may include a data type component 525, a block selection component 530, a data writing component 535, a segment component 540, a counter component 545, a list component 550, an invalid data component 555, a command reception component 560, or any combination thereof. Each of these components may communicate, directly or indirectly, with one another (e.g., via one or more buses).

The data type component 525 may be configured as or otherwise support a means for determining a type of data associated with data to be written to a memory system. The block selection component 530 may be configured as or otherwise support a means for selecting a block of the memory system for storing the data, where the block is selected from a plurality of blocks of the memory system based at least in part on the type of data and a quantity of times that the block has been erased. The data writing component 535 may be configured as or otherwise support a means for writing the data to the block based at least in part on selecting the block.

In some examples, the block selection component 530 may be configured as or otherwise support a means for selecting a second block of the memory system for storing second data of a second type of data based at least in part on the second type of data and a second quantity of times that the second block has been erased, where the second quantity of times that the second block has been erased is greater than the quantity of times that the block has been erased based at least in part on the type of data being associated with a first expected life duration that is less than a second expected life duration associated with the second type of data. In some examples, the data writing component 535 may be configured as or otherwise support a means for writing the second data to the second block based at least in part on selecting the second block.

In some examples, the block selection component 530 may be configured as or otherwise support a means for selecting a third block of the memory system for storing third data of a third type of data based at least in part on the third type of data and a third quantity of times that the third block has been erased, where the third quantity of times that the third block has been erased is less than the quantity of times that the block has been erased based at least in part on the type of data being associated with a first expected life duration that is greater than a third expected life duration associated with the third type of data. In some examples, the data writing component 535 may be configured as or otherwise support a means for writing the third data to the third block based at least in part on selecting the third block.

In some examples, to support determining the type of data, the data type component 525 may be configured as or otherwise support a means for predicting the type of data based at least in part on a second quantity of times that a range of logical addresses including a logical address of the data has been accessed, a quantity of invalid data included in a set of previously selected blocks, or a combination thereof, where the set of previously selected blocks correspond to a threshold quantity of blocks recently selected by the memory system.

In some examples, to support determining the type of data, the segment component 540 may be configured as or otherwise support a means for identifying a segment of a mapping of the memory system, the mapping for translating logical addresses to physical addresses of the memory system, the segment including a subset of logical addresses of the mapping that includes a logical address of the data. In some examples, to support determining the type of data, the counter component 545 may be configured as or otherwise support a means for determining a value of a counter that tracks a quantity of times that respective data is written to a respective logical address included in the segment, where the type of data is based at least in part on the value of the counter.

In some examples, the command reception component 560 may be configured as or otherwise support a means for receiving a write command including second data having a second logical address included in the segment. In some examples, the counter component 545 may be configured as or otherwise support a means for incrementing the value of the counter based on the second data having the second logical address included in the segment, where the value of the counter is based at least in part on the incrementing.

In some examples, the counter component 545 may be configured as or otherwise support a means for comparing the value of the counter to respective values of a plurality of counters associated with a plurality of segments of the mapping. In some examples, to support determining the type of data, the counter component 545 may be configured as or otherwise support a means for determining the value of the counter relative to the respective values of the plurality of counters based at least in part on the comparing.

In some examples, the counter component 545 may be configured as or otherwise support a means for comparing the value of the counter to a threshold associated with the type of data. In some examples, to support determining the type of data, the counter component 545 may be configured as or otherwise support a means for determining whether the value of the counter satisfies the threshold.

In some examples, respective values of a plurality counters including the counter and associated with a plurality of segments of the mapping are stored to a memory device of the memory system that includes volatile memory cells.

In some examples, the list component 550 may be configured as or otherwise support a means for maintaining a list of a set of previously selected blocks, where the set of previously selected blocks correspond to a threshold quantity of blocks recently selected by the memory system. In some examples, to support determining the type of data, the invalid data component 555 may be configured as or otherwise support a means for determining a quantity of invalid data in the set of previously selected blocks.

In some examples, the invalid data component 555 may be configured as or otherwise support a means for determining that the quantity of invalid data in the set of previously selected blocks satisfies a threshold quantity of invalid data, where determining the type of data is based at least in part on determining that the quantity of invalid data satisfies the threshold quantity of invalid data. In some examples, the block selection component 530 may be configured as or otherwise support a means for determining that the quantity of times that the block has been erased is less than a threshold erase quantity based at least in part on determining the type of data, where selecting the block is based at least in part on that the quantity of times that block has been erased is less than the threshold erase quantity.

In some examples, the invalid data component 555 may be configured as or otherwise support a means for determining that the quantity of invalid data in the set of previously selected blocks fails to satisfy a threshold quantity of invalid data, where determining the type of data is based at least in part on determining that the quantity of invalid data fails to satisfy the threshold quantity of invalid data. In some examples, the block selection component 530 may be configured as or otherwise support a means for determining that the quantity of times that the block has been erased is greater than a threshold erase quantity based at least in part on determining the type of data, where selecting the block is based at least in part on that the quantity of times that block has been erased is greater than the threshold erase quantity.

In some examples, the list of the set of previously selected blocks is stored to a memory device of the memory system that includes volatile memory cells.

In some examples, to support determining the type of data, the command reception component 560 may be configured as or otherwise support a means for receiving, from a host system, a write command including the data and an indication of the type of data, where the type of data is determined based at least in part on the indication of the type of data and a prediction, by the memory system, of the type of data.

In some examples, the type of data is determined based at least in part on a weighted combination of the indication of the type of data and the prediction of the type of data.

In some examples, the data is written in response to a write command received from a host system.

In some examples, the data is written as part of a garbage collection operation associated with moving the data from a second block to the block.

FIG. 6 shows a flowchart illustrating a method 600 that supports dynamic wear leveling techniques in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include determining a type of data associated with data to be written to a memory system. The operations of 605 may be performed in accordance with examples as disclosed herein. In some examples, aspects of the operations of 605 may be performed by a data type component 525 as described with reference to FIG. 5.

At 610, the method may include selecting a block of the memory system for storing the data, where the block is selected from a plurality of blocks of the memory system based at least in part on the type of data and a quantity of times that the block has been erased. The operations of 610 may be performed in accordance with examples as disclosed herein. In some examples, aspects of the operations of 610 may be performed by a block selection component 530 as described with reference to FIG. 5.

At 615, the method may include writing the data to the block based at least in part on selecting the block. The operations of 615 may be performed in accordance with examples as disclosed herein. In some examples, aspects of the operations of 615 may be performed by a data writing component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining a type of data associated with data to be written to a memory system; selecting a block of the memory system for storing the data, where the block is selected from a plurality of blocks of the memory system based at least in part on the type of data and a quantity of times that the block has been erased; and writing the data to the block based at least in part on selecting the block.

Aspect 2: The method, apparatus, or non-transitory computer-readable medium of aspect 1, further including operations, features, circuitry, logic, means, or instructions, or any combination thereof for selecting a second block of the memory system for storing second data of a second type of data based at least in part on the second type of data and a second quantity of times that the second block has been erased, where the second quantity of times that the second block has been erased is greater than the quantity of times that the block has been erased based at least in part on the type of data being associated with a first expected life duration that is less than a second expected life duration associated with the second type of data and writing the second data to the second block based at least in part on selecting the second block.

Aspect 3: The method, apparatus, or non-transitory computer-readable medium of any of aspects 1 through 2, further including operations, features, circuitry, logic, means, or instructions, or any combination thereof for selecting a third block of the memory system for storing third data of a third type of data based at least in part on the third type of data and a third quantity of times that the third block has been erased, where the third quantity of times that the third block has been erased is less than the quantity of times that the block has been erased based at least in part on the type of data being associated with a first expected life duration that is greater than a third expected life duration associated with the third type of data and writing the third data to the third block based at least in part on selecting the third block.

Aspect 4: The method, apparatus, or non-transitory computer-readable medium of any of aspects 1 through 3, where determining the type of data includes operations, features, circuitry, logic, means, or instructions, or any combination thereof for predicting the type of data based at least in part on a second quantity of times that a range of logical addresses including a logical address of the data has been accessed, a quantity of invalid data included in a set of previously selected blocks, or a combination thereof, where the set of previously selected blocks correspond to a threshold quantity of blocks recently selected by the memory system.

Aspect 5: The method, apparatus, or non-transitory computer-readable medium of any of aspects 1 through 4, where determining the type of data includes operations, features, circuitry, logic, means, or instructions, or any combination thereof for identifying a segment of a mapping of the memory system, the mapping for translating logical addresses to physical addresses of the memory system, the segment including a subset of logical addresses of the mapping that includes a logical address of the data and determining a value of a counter that tracks a quantity of times that respective data is written to a respective logical address included in the segment, where the type of data is based at least in part on the value of the counter.

Aspect 6: The method, apparatus, or non-transitory computer-readable medium of aspect 5, further including operations, features, circuitry, logic, means, or instructions, or any combination thereof for receiving a write command including second data having a second logical address included in the segment and incrementing the value of the counter based on the second data having the second logical address included in the segment, where the value of the counter is based at least in part on the incrementing.

Aspect 7: The method, apparatus, or non-transitory computer-readable medium of any of aspects 5 through 6, further including operations, features, circuitry, logic, means, or instructions, or any combination thereof for comparing the value of the counter to respective values of a plurality of counters associated with a plurality of segments of the mapping, where determining the type of data includes and determining the value of the counter relative to the respective values of the plurality of counters based at least in part on the comparing.

Aspect 8: The method, apparatus, or non-transitory computer-readable medium of any of aspects 5 through 7, further including operations, features, circuitry, logic, means, or instructions, or any combination thereof for comparing the value of the counter to a threshold associated with the type of data, where determining the type of data includes and determining whether the value of the counter satisfies the threshold.

Aspect 9: The method, apparatus, or non-transitory computer-readable medium of any of aspects 5 through 8, where respective values of a plurality counters including the counter and associated with a plurality of segments of the mapping are stored to a memory device of the memory system that includes volatile memory cells.

Aspect 10: The method, apparatus, or non-transitory computer-readable medium of any of aspects 1 through 9, further including operations, features, circuitry, logic, means, or instructions, or any combination thereof for maintaining a list of a set of previously selected blocks, where the set of previously selected blocks correspond to a threshold quantity of blocks recently selected by the memory system, where determining the type of data includes and determining a quantity of invalid data in the set of previously selected blocks.

Aspect 11: The method, apparatus, or non-transitory computer-readable medium of aspect 10, further including operations, features, circuitry, logic, means, or instructions, or any combination thereof for determining that the quantity of invalid data in the set of previously selected blocks satisfies a threshold quantity of invalid data, where determining the type of data is based at least in part on determining that the quantity of invalid data satisfies the threshold quantity of invalid data and determining that the quantity of times that the block has been erased is less than a threshold erase quantity based at least in part on determining the type of data, where selecting the block is based at least in part on that the quantity of times that block has been erased is less than the threshold erase quantity.

Aspect 12: The method, apparatus, or non-transitory computer-readable medium of aspect 10, further including operations, features, circuitry, logic, means, or instructions, or any combination thereof for determining that the quantity of invalid data in the set of previously selected blocks fails to satisfy a threshold quantity of invalid data, where determining the type of data is based at least in part on determining that the quantity of invalid data fails to satisfy the threshold quantity of invalid data and determining that the quantity of times that the block has been erased is greater than a threshold erase quantity based at least in part on determining the type of data, where selecting the block is based at least in part on that the quantity of times that block has been erased is greater than the threshold erase quantity.

Aspect 13: The method, apparatus, or non-transitory computer-readable medium of any of aspects 10 through 12, where the list of the set of previously selected blocks is stored to a memory device of the memory system that includes volatile memory cells.

Aspect 14: The method, apparatus, or non-transitory computer-readable medium of any of aspects 1 through 13, where determining the type of data further includes operations, features, circuitry, logic, means, or instructions, or any combination thereof for receiving, from a host system, a write command including the data and an indication of the type of data, where the type of data is determined based at least in part on the indication of the type of data and a prediction, by the memory system, of the type of data.

Aspect 15: The method, apparatus, or non-transitory computer-readable medium of aspect 14, where the type of data is determined based at least in part on a weighted combination of the indication of the type of data and the prediction of the type of data.

Aspect 16: The method, apparatus, or non-transitory computer-readable medium of any of aspects 1 through 15, where the data is written in response to a write command received from a host system.

Aspect 17: The method, apparatus, or non-transitory computer-readable medium of any of aspects 1 through 16, where the data is written as part of a garbage collection operation associated with moving the data from a second block to the block.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory device comprising non-volatile memory cells; and
a controller associated with the memory device, wherein the controller is configured to cause the apparatus to:
determine a type of data associated with data to be written to a memory system;
select a block of the memory system for storing the data, wherein the block is selected from a plurality of blocks of the memory system based at least in part on the type of data and a quantity of times that the block has been erased; and
write the data to the block based at least in part on selecting the block.

2. The apparatus of claim 1, wherein the controller is further configured to cause the apparatus to:
select a second block of the memory system for storing second data of a second type of data based at least in part on the second type of data and a second quantity of times that the second block has been erased, wherein the second quantity of times that the second block has been erased is greater than the quantity of times that the block has been erased based at least in part on the type of data being associated with a first expected life duration that is less than a second expected life duration associated with the second type of data; and
write the second data to the second block based at least in part on selecting the second block.

3. The apparatus of claim 1, wherein the controller is further configured to cause the apparatus to:
select a third block of the memory system for storing third data of a third type of data based at least in part on the third type of data and a third quantity of times that the third block has been erased, wherein the third quantity of times that the third block has been erased is less than the quantity of times that the block has been erased based at least in part on the type of data being associated with a first expected life duration that is greater than a third expected life duration associated with the third type of data; and
write the third data to the third block based at least in part on selecting the third block.

4. The apparatus of claim 1, wherein, to determine the type of data, the controller is configured to cause the apparatus to:
predict the type of data based at least in part on a second quantity of times that a range of logical addresses comprising a logical address of the data has been accessed, a quantity of invalid data included in a set of previously selected blocks, or a combination thereof, wherein the set of previously selected blocks correspond to a threshold quantity of blocks recently selected by the memory system.

5. The apparatus of claim 1, wherein, to determine the type of data, the controller is configured to cause the apparatus to:
identify a segment of a mapping of the memory system, the mapping for translating logical addresses to physical addresses of the memory system, the segment comprising a subset of logical addresses of the mapping that comprises a logical address of the data; and
determine a value of a counter that tracks a quantity of times that respective data is written to a respective logical address included in the segment, wherein the type of data is based at least in part on the value of the counter.

6. The apparatus of claim 5, wherein the controller is further configured to cause the apparatus to:
receive a write command comprising second data having a second logical address included in the segment; and
increment the value of the counter based on the second data having the second logical address included in the segment, wherein the value of the counter is based at least in part on the incrementing.

7. The apparatus of claim 5, wherein the controller is further configured to cause the apparatus to:
compare the value of the counter to respective values of a plurality of counters associated with a plurality of segments of the mapping, wherein, to determine the type of data, the controller is configured to cause the apparatus to:
determine the value of the counter relative to the respective values of the plurality of counters based at least in part on the comparing.

8. The apparatus of claim 5, wherein the controller is further configured to cause the apparatus to:
compare the value of the counter to a threshold associated with the type of data, wherein to determine the type of data, the controller is configured to cause the apparatus to:
determine whether the value of the counter satisfies the threshold.

9. The apparatus of claim 5, wherein respective values of a plurality counters comprising the counter and associated with a plurality of segments of the mapping are stored to a memory device of the memory system that comprises volatile memory cells.

10. The apparatus of claim 1, wherein the controller is further configured to cause the apparatus to:
maintain a list of a set of previously selected blocks, wherein the set of previously selected blocks correspond to a threshold quantity of blocks recently selected by the memory system, wherein to determine the type of data, the controller is configured to cause the apparatus to:
determine a quantity of invalid data in the set of previously selected blocks.

11. The apparatus of claim 10, wherein the controller is further configured to cause the apparatus to:
determine that the quantity of invalid data in the set of previously selected blocks satisfies a threshold quantity of invalid data, wherein determining the type of data is based at least in part on determining that the quantity of invalid data satisfies the threshold quantity of invalid data; and
determine that the quantity of times that the block has been erased is less than a threshold erase quantity based at least in part on determining the type of data, wherein selecting the block is based at least in part on that the quantity of times that block has been erased is less than the threshold erase quantity.

12. The apparatus of claim 10, wherein the controller is further configured to cause the apparatus to:
determine that the quantity of invalid data in the set of previously selected blocks fails to satisfy a threshold quantity of invalid data, wherein determining the type of data is based at least in part on determining that the quantity of invalid data fails to satisfy the threshold quantity of invalid data; and
determine that the quantity of times that the block has been erased is greater than a threshold erase quantity based at least in part on determining the type of data, wherein selecting the block is based at least in part on that the quantity of times that block has been erased is greater than the threshold erase quantity.

13. The apparatus of claim 10, wherein the list of the set of previously selected blocks is stored to a memory device of the memory system that comprises volatile memory cells.

14. The apparatus of claim 1, wherein, to determine the type of data, the controller is configured to cause the apparatus to:
receive, from a host system, a write command comprising the data and an indication of the type of data, wherein the type of data is determined based at least in part on the indication of the type of data and a prediction, by the memory system, of the type of data.

15. The apparatus of claim 14, wherein the type of data is determined based at least in part on a weighted combination of the indication of the type of data and the prediction of the type of data.

16. The apparatus of claim 1, wherein the data is written in response to a write command received from a host system.

17. The apparatus of claim 1, wherein the data is written as part of a garbage collection operation associated with moving the data from a second block to the block.

18. A non-transitory computer-readable medium storing code comprising instructions which, when executed by a processor of an electronic device, cause the electronic device to:
determine a type of data associated with data to be written to a memory system;
select a block of the memory system for storing the data, wherein the block is selected from a plurality of blocks of the memory system based at least in part on the type of data and a quantity of times that the block has been erased; and
write the data to the block based at least in part on selecting the block.

19. The non-transitory computer-readable medium of claim 18, wherein the instructions to determine the type of data, when executed by the processor of the electronic device, cause the electronic device to:
predict the type of data based at least in part on a second quantity of times that a range of logical addresses comprising a logical address of the data has been accessed, a quantity of invalid data included in a set of previously selected blocks, or a combination thereof, wherein the set of previously selected blocks correspond to a threshold quantity of blocks recently selected by the memory system.

20. The non-transitory computer-readable medium of claim 18, wherein the instructions to determine the type of data, when executed by the processor of the electronic device, cause the electronic device to:
identify a segment of a mapping of the memory system, the mapping for translating logical addresses to physical addresses of the memory system, the segment comprising a subset of logical addresses of the mapping that comprises a logical address of the data; and
determine a value of a counter that tracks a quantity of times that respective data is written to a respective logical address included in the segment, wherein the type of data is based at least in part on the value of the counter.

21. The non-transitory computer-readable medium of claim 20, wherein the instructions, when executed by the processor of the electronic device, further cause the electronic device to:
receive a write command comprising second data having a second logical address included in the segment; and
increment the value of the counter based on the second data having the second logical address included in the segment, wherein the value of the counter is based at least in part on the incrementing.

22. The non-transitory computer-readable medium of claim 20, wherein the instructions, when executed by the processor of the electronic device, further cause the electronic device to:
compare the value of the counter to respective values of a plurality of counters associated with a plurality of segments of the mapping, wherein the instructions to determine the type of data, when executed by the processor of the electronic device, cause the electronic device to:
determine the value of the counter relative to the respective values of the plurality of counters based at least in part on the comparing.

23. The non-transitory computer-readable medium of claim 18, wherein the instructions are further executable by the processor to:
maintain a list of a set of previously selected blocks, wherein the set of previously selected blocks correspond to a threshold quantity of blocks recently selected by the memory system, wherein the instructions to determine the type of data, when executed by the processor of the electronic device, cause the electronic device to:
determine a quantity of invalid data in the set of previously selected blocks.

24. The non-transitory computer-readable medium of claim 18, wherein the instructions to determine the type of data, when executed by the processor of the electronic device, cause the electronic device to:
receive, from a host system, a write command comprising the data and an indication of the type of data, wherein the type of data is determined based at least in part on the indication of the type of data and a prediction, by the memory system, of the type of data.

25. A method, comprising:
determining a type of data associated with data to be written to a memory system;
selecting a block of the memory system for storing the data, wherein the block is selected from a plurality of blocks of the memory system based at least in part on the type of data and a quantity of times that the block has been erased; and
writing the data to the block based at least in part on selecting the block.
